(19) United States
(12) Patent Application Publication
(10) Pub. No.: US 2020/0359666 A1
(43) Pub. Date: Nov. 19, 2020

(54) Textured Hot Dog and a Method to Manufacture a Flat Dog

(71) Applicant: Original Round Dog LLC, Sewell, NJ (US)

(72) Inventors: Richard A. Tarantino, JR., North Attleboro, MA (US); Michael Lucidonio, Sewell, NJ (US); Anthony Lucidonio, JR., Philadelphia, PA (US)

(21) Appl. No.: 15/931,975

(22) Filed: May 14, 2020

Related U.S. Application Data
(60) Provisional application No. 62/847,762, filed on May 14, 2019.

(51) Int. Cl. A23L 13/60; A23L 13/50; A23J 3/26; A23L 5/10; A23J 3/14

(52) U.S. Cl. CPC A23L 13/67; A23L 13/62; A23L 13/57; A23J 3/14; A23J 3/26; A23L 5/17; A23L 13/52

(57) ABSTRACT

A method of producing a hot dog-like product that is flat and textured on both the exterior and cut face surface area of the product following slicing or cutting. This unique method of manufacturing a hot dog allows for a textured exterior made by producing the raw product in a flexible, permeable, casing that is covered with netting or other material to produce a texture on the exterior surface of the product. This is then stripped off using another process of coating the casing with an easy peel spray that allows the casing to be removed leaving a smooth hot dog like exterior surface. When the log is cut, we utilize a second unique process of cutting it with a textured blade to produce a textured surface area on either the top and/or bottom or both top and bottom of the product.

### CROSS-REFERENCE TO RELATED PATENT APPLICATIONS

This patent application claims a benefit to the May 14, 2020 filing date of U.S. Provisional Patent Application Ser. No. 62/847,762 titled “Textured Hot Dog and a Method of Manufacture” by Tarantino Jr. et al. The disclosure of U.S. 62/847,762 is incorporated by reference herein in its entirety.

### BACKGROUND

### 1. Field of the Disclosure

Disclosed herein is a processed food product and method of manufacture. In particular, a hot dog like product is flat and textured on both its exterior surface and cut surfaces.

### 2. Background of the Disclosure

Hot dogs are ubiquitous at homes, schools and sporting events. While condiments such as ketchup and mustard adhere well to the cylindrical surface of a hot dog, toppings such as relish and onions frequently slide off the cylindrical surface and may wind up on floor or lap of the consumer.

While cylindrical slabs of processed meat are known, such as bologna slices, such slabs frequently bow when heated leading to uneven heating. Edges of the slab are prone to burning while bowed middle portions are inadequately heated.

Disclosed herein is a unique hot dog that does not have the above recited disadvantages.

### SUMMARY OF THE DISCLOSURE

The disc shaped patty and texture provided the below processed food product has advantages compared to traditional hot dogs and sausages. The flat shape allows it to be more easily consumed and it fits on any round shaped bread or roll. There is no need to purchase separate hot dog and hamburger rolls as it fits perfectly on a traditional hamburger roll because of its unique shape. A textured cut across a preformed log increases the surface area over a traditional hot dog or sausage shape allowing it to cook more evenly and to develop a more caramelized surface area for flavor enhancement. In addition, the textured surface of the cut raises up the surface allowing air and liquid to flow improving the cooking process and preventing burning. The appearance is also enhanced by leaving grill marks on the surface.

It can be eaten and easily stacked with various toppings on a round bread or bun. Unlike a traditional cylinder-shaped hot dog, the flat and textured surfaces help keep the toppings in place and the product from sliding off the bread or bun.

One difference in the manufacturing process is that the process textures the exterior of the product to look like stacked hotdogs to be recognizable by consumers. This exterior surface also serves to keep the product's shape when further heated, cooked or grilled. The surface is textured to produce grill lines even when cooked on a flat surface. Exemplary cut textures are a waffle pattern and a wedge cut. The textured surface also allows for the product to cook more evenly and not become misconfigured or to “cup” when heating or grilling. Another advantage is that this unique shape for a hot dog allows for use on a traditional round shaped roll or bread. Consumers are able to place condiments on the surface and stack other foods, such as pickles and onion, that would normally roll or fall off a traditionally shaped hot dog. The use of a flexible and permeable casing allows for the product to be shaped in unique textures and for flavor, smoke and moisture to permeate the casing during cooking.

The process advantageously allows for the use of various fillings to be formed into this unique textured shape and texture cut. The filling can be meat, poultry, vegetable or seafood based, as well as combinations thereof, to produce an improved shape that is easier to consume and easily used on round breads and rolls. This makes it easier to hold and consume, especially for children. The unique shape provides a safer bite to be taken from a flat surface that is less likely to slide in a child's mouth.

### BRIEF DESCRIPTION OF THE DRAWINGS

FIG. 1 shows an elastic netting covering a fibrous casing effective to texture edges of a food product.

FIG. 2 illustrates the food product stuffed in the fibrous casing prior to cooking.

FIG. 3 illustrates the food product stuffed in the fibrous casing after cooking.

FIG. 4 illustrates the food product removed from the fibrous casing after cooking.

FIG. 5 illustrates a cutting tool effective to texture planar surfaces of the food product.

FIG. 6 illustrates a portion of the food product served on a hamburger roll.

FIG. 7 illustrates a semi-automatic slicing and texturing apparatus.

FIG. 8 illustrates a rotating cutting blade for an automatic slicing and texturing apparatus.

### DETAILED DESCRIPTION

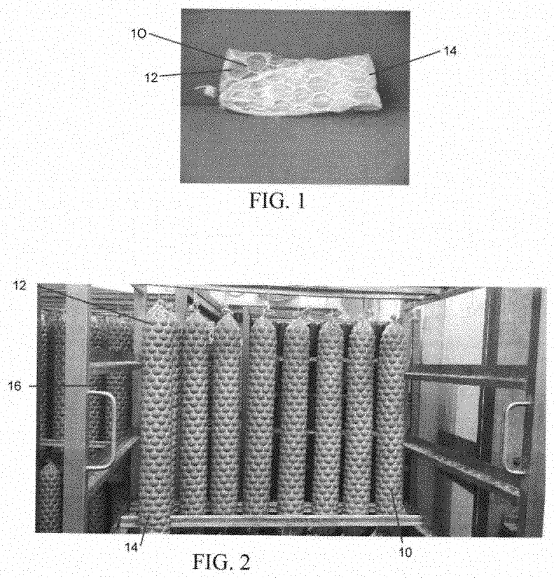

FIG. 1 illustrates an elastic netting 10 covering a fibrous casing 12. This combination is effective to texture edges of a food product. The fibrous casing 12 is typically formed from collagen reinforced by a silk or nylon tube. This casing is typically called a Hukki casing and may be purchased from Global Casing (Carlstadt, N.J.). The elastic netting 10 has a honeycomb configuration with opening of any desired shape, such as the illustrated hexagons. This provides a stacked dog appearance to the finished product. The texture, size of texture and shape of texture may vary.

The casing 12 is made removeable by coating its interior with an easy peeling release agent, such as a protein-lined collagen that sticks to the exterior of the food product 14 giving the cooked product a smooth finish.

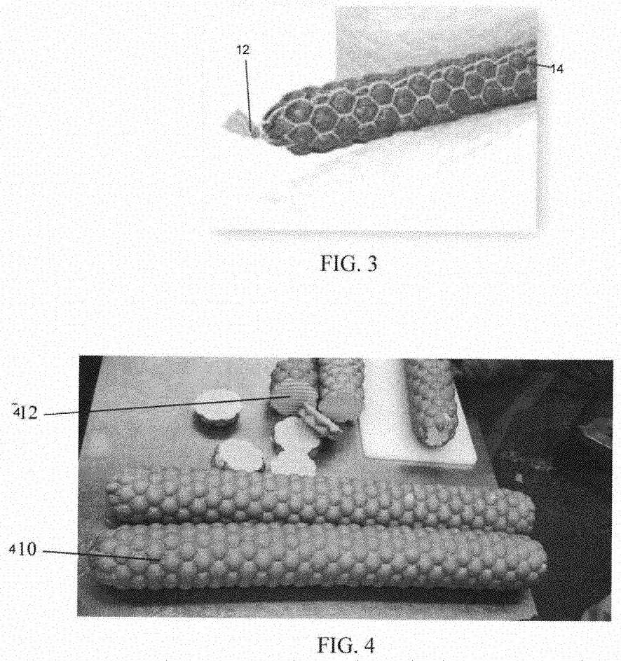

The casing 12 is then filled with a food product 14. The filling may be a meat, poultry, vegetable or seafood based emulsion. Combinations of these fillings as well as other edible products may be used. FIG. 2 illustrates the food product 14 stuffed in the fibrous casing 12 prior to cooking. The process is to emulsify the filling and then pump it under pressure (12-22 pounds per square inch of pressure) to expand the flexible casing, with the netting 10. The exterior texture 16 of the food product is formed when the casing 12 expands outside the netting 10 or other material that is placed together with the casing to form the desired texture. The food product is extruded through apertures in the netting forming semispherical protrusions that simulate the appearance of stacked hot dogs. This forms a log to be cooked. Cooking may include a combination of wet and dry cooking in a smoke house or commercial oven to develop a desired flavor. FIG. 3 illustrates the food product 14 stuffed in the fibrous casing 12 after cooking.

The cooked food product log is then hydrated to 15% to 25% moisture (by volume) depending on the relative humidity and the casing stripped off the log. FIG. 4 shows a log 410 stripped of casing. The stripped log 410 is then cut using a textured knife (with various textures and finishes) to form a disc shaped patty with a unique texture of planar surface areas 412. This can be done to the top, bottom or both sides of the product during cutting. A waffle blade 22 as shown in FIG. 5 provides parallel grooves as one such texture. Other textures may be obtained with other cutting tools that may be hand operated or part of a slicing machine. The slicing machine may be for automated slicing or for hand slicing. Various product will be produced with different cutting textures including, but not limited to, smooth, waffle, beveled and criss-cross.

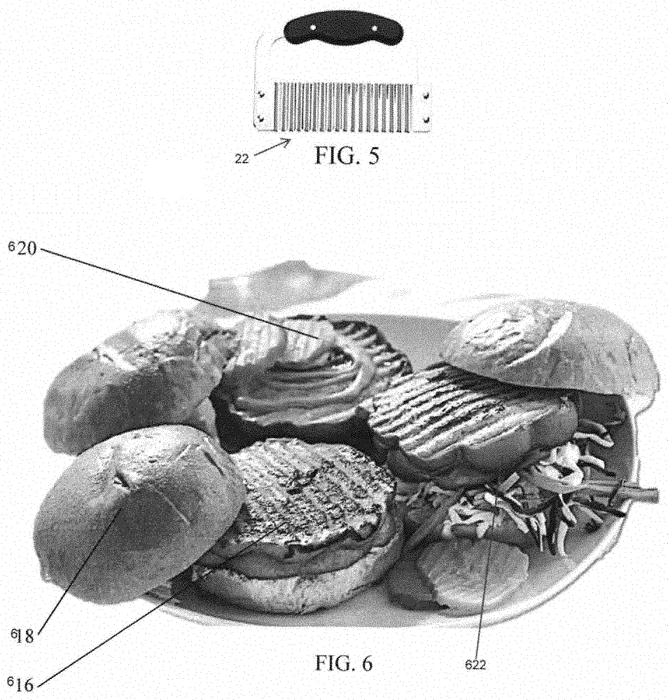

FIG. 6 illustrates a portion of the food product served on a hamburger roll. The disc shaped patty has a top surface and a bottom surface. These two surfaces are generally coplanar to provide a disc shape. The top surface and the bottom surface are separated by an edge. There is a first texture formed into the edge and a second texture formed into the top and bottom surfaces. The sliced product 616 may be grilled or otherwise further cooked and is sized to fit on a conventional roll, such as hamburger bun 618. Unlike a cylindrical hot dog on a hot dog bun, condiments 620 easily remain in place on the sliced product 616. Product exterior edges 622 may have an appearance of stacked hot dogs.

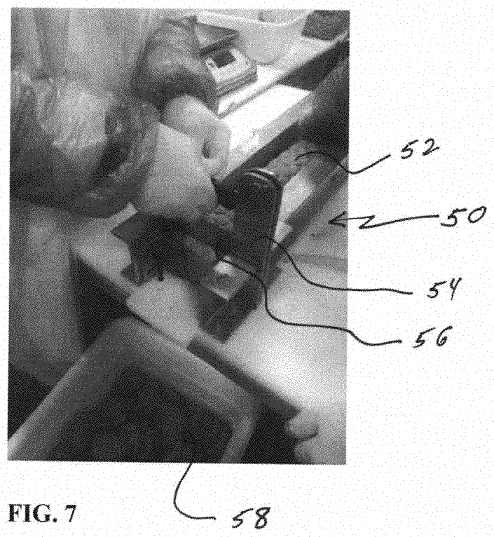

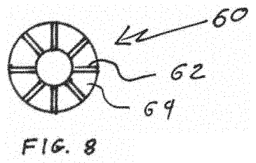

FIG. 7 illustrates a semi-automatic slicing and texturing apparatus 50. A cooked log 52 of food product is transferred by a conveyor belt to a slicer 54 having a textured blade 56. When the slicer is raised, the cooked log is advanced a desired distance beyond the textured blade 56. The blade is then depressed generating a textured sliced product 58. Referencing FIG. 8, the slicer may be replaced with a cutting wheel 60 having a plurality of cutting blades 62 separated by open spaces 64. The cutting wheel and conveyor belt are synchronized so that a desired thickness of cooked log passes through an open space before being sliced by textured blade 62.

We claim:

1. A food product, comprising:
a disc shaped patty having:
a top surface;
a bottom surface that is generally coplanar with the top surface and spaced from the top surface by an edge;
a first texture formed into the edge; and
a second texture formed into both the top surface and the bottom surface.

2. The food product of claim 1 wherein the first texture is semispherical.

3. The food product of claim 2 wherein the first texture simulates terminal ends of hot dogs.

4. The food product of claim 2 wherein the second texture is selected from the group consisting of parallel grooves, waffle, beveled and criss-cross.

5. The food product of claim 4 wherein the second texture is parallel grooves.

6. The food product of claim 2 beings selected from the group consisting of meat, poultry, vegetable and seafood and combinations thereof

7. A food product contained within an elastic netting configured to expand through the netting when pressurized.

8. The food product of claim 7 wherein a removable casing is disposed between the food product and the elastic netting.

9. The food product of claim 8 wherein the elastic netting has a honeycomb configuration.

10. A method for the manufacture of a textured food product, comprising:
inserting a filling of the food product into an elastic netting configured to impart a desired first texture to edges of the food product;
causing the food product to expand through apertures in the elastic netting;
cooking the food product to form a cooked log;
removing the cooked log from the elastic netting; and
slicing the cooked log with a cutting tool configured to impart a second texture on generally coplanar top and bottom surfaces of the food product.

11. The method of claim 10 including disposing a casing between the elastic netting and the food product prior to cooking.

12. The method of claim 11 wherein a surface of the casing that contacts the food product is coated with a release agent.

13. The method of claim 12 wherein the release agent is a protein-lined collagen.

14. The method of claim 12 wherein the food product is pressurized prior to cooking thereby causing expansion through the apertures in the elastic netting.

15. The method of claim 14 wherein the food product is pressurized to between 12 and 22 pound per square inch of pressure.

16. The method of claim 14 wherein the cooked log is cut into slabs with a textured blade.

17. The method of claim 16 wherein the textured blade is a component of a hand slicer.

18. The method of claim 16 wherein the textured blade is a component of an automatic slicer.
